(19) United States
(12) Patent Application Publication
(10) Pub. No.: US 2010/0307206 A1
(43) Pub. Date: Dec. 9, 2010

(54) ELECTRONIC DOOR LOCK FOR REDUCED POWER CONSUMPTION

(75) Inventors: Ronald Taylor, Wheaton, IL (US); Jane Liu, South Elgin, IL (US); Gustavo Sumcad, Westfield, IN (US)

Correspondence Address: MICHAEL BEST & FRIEDRICH LLP, 100 E WISCONSIN AVENUE, Suite 3300, MILWAUKEE, WI, 53202, US

(73) Assignee: HARROW PRODUCTS LLC, Montvale, NJ (US)

(21) Appl. No.: 12/796,425

(22) Filed: Jun. 8, 2010

Related U.S. Application Data
(60) Provisional application No. 61/185,127, filed on Jun. 8, 2009.

(51) Int. Cl. E05B 65/00; G06F 7/04

(52) U.S. Cl. 70/91; 340/5.6

(57) ABSTRACT

A lock system includes an access point including a portion movable between an open position and a closed position and a lock mechanism coupled to the access point and movable between a locked position in which the access point is maintained in the closed position and an unlocked position in which the access point is freely movable between the open position and the closed position. A wireless module is coupled to the lock mechanism and is operable to move the lock mechanism between the locked position and the unlocked position. The wireless module includes a receiver operable in a first mode to periodically listen for a signal and operable in a second mode in response to receipt of the signal to receive data, the first mode consuming a first amount of power that is less than a second amount of power consumed during operation in the second mode.

### RELATED APPLICATION DATA

This application claims priority to co-pending provisional patent application No. 61/185,127 filed Jun. 8, 2009, the entire contents of which are incorporated herein by reference.

### BACKGROUND

The present invention relates to access control systems, and more particularly to an electronic door lock used including power saving features and used in an access control system.

Access control systems that utilize wireless communication between the various access points and a central access controller provide some advantageous to wired systems. However, the need for communication between the various components creates a large power requirement.

### SUMMARY

In one construction, the invention provides an electronic door lock that includes a remote portion and a plurality of access portions. The access portions communicate wirelessly with the remote portion. Each access portion is configured to receive a user credential and includes a database and a processor that selectively compares the received credential to the database to make an access decision. Alternatively, the access portion transmits the credential to the remote portion which also includes a database and a processor that selectively compares the credential to the database to make an access decision that is transmitted to the access portion. Alternatively, the access decision is made at the access portion and an audit log is created and transmitted to the remote portion.

In another construction, the invention provides a lock system that includes an access point including a portion movable between an open position and a closed position and a lock mechanism coupled to the access point and movable between a locked position in which the access point is maintained in the closed position and an unlocked position in which the access point is freely movable between the open position and the closed position. A wireless module is coupled to the lock mechanism and is operable to move the lock mechanism between the locked position and the unlocked position. The wireless module includes a receiver operable in a first mode to periodically listen for a signal and operable in a second mode in response to receipt of the signal to receive data, the first mode consuming a first amount of power that is less than a second amount of power consumed during operation in the second mode.

In yet another construction, the invention provides a lock system that includes an access point having a portion that is movable between an open position and a closed position and a lock mechanism coupled to the access point and movable between a locked position in which the access point is maintained in the closed position and an unlocked position in which the access point is freely movable between the open position and the closed position. A first receiver is periodically operable at a first power level to detect a beacon. A second receiver, separate from the first receiver is operable at a second power level greater than the first power level to receive data. The second receiver is operable in a sleep mode and an active mode, the second receiver transitioning from the sleep mode to the active mode in response to receipt of the beacon by the first receiver.

In another construction, the invention provides a method of operating a wireless lock system. The method includes periodically operating a plurality of receivers at a low power level to detect a beacon. Each receiver is associated with a different lock mechanism. The method also includes transitioning each receiver to a high power level in response to detection of the beacon, receiving data using each receiver while operating at the high power level, and transitioning each lock mechanism to one of a locked position and an unlocked position in response to the received data.

In another construction, the invention provides an electronic door lock that includes a remote portion and a plurality of access portions. The access portions operate in a sleep mode when not performing an access operation and include a transceiver that periodically listens for a beacon. The beacon is transmitted by the remote portion when data needs to be transmitted to the access portion or when commands need to be executed by the access portions. Upon receiving the beacon, the access portions enter a heartbeat mode and download the necessary data and commands, and upload any audit records contained in the access portions.

Other aspects of the invention will become apparent by consideration of the detailed description and accompanying drawings.

### BRIEF DESCRIPTION OF THE DRAWINGS

FIG. 1 is a side view of an electronic door lock mounted to a door.

FIG. 2 is a schematic illustration of the electronic door lock of FIG. 1 and a plurality of credential readers configured for mounting on the electronic door lock.

FIG. 3 is a schematic illustration of the electronic door lock of FIG. 1 and a plurality of communication module covers configured for mounting on the electronic door lock.

FIG. 4 is a perspective view of the electronic door lock of FIG. 1 including an attachment interface.

FIG. 5 is a perspective view of a portion of the electronic door lock of FIG. 1 illustrating a communication module.

FIG. 6 is a perspective view of a portion of the electronic door lock of FIG. 1 illustrating another construction of a communication module.

FIG. 7 is a sectional view of the electronic door lock of FIG. 1 taken along line 7-7 of FIG. 2.

FIG. 8 is a schematic illustration of an access control system including the electronic door lock of FIG. 1.

FIG. 9 is a schematic illustration of an electromechanical system of the door lock of FIG. 1.

FIG. 10 is a schematic illustration of a lock control system that employs wireless communication.

FIG. 11 is a schematic illustration of a portion of the lock control system of FIG. 10.

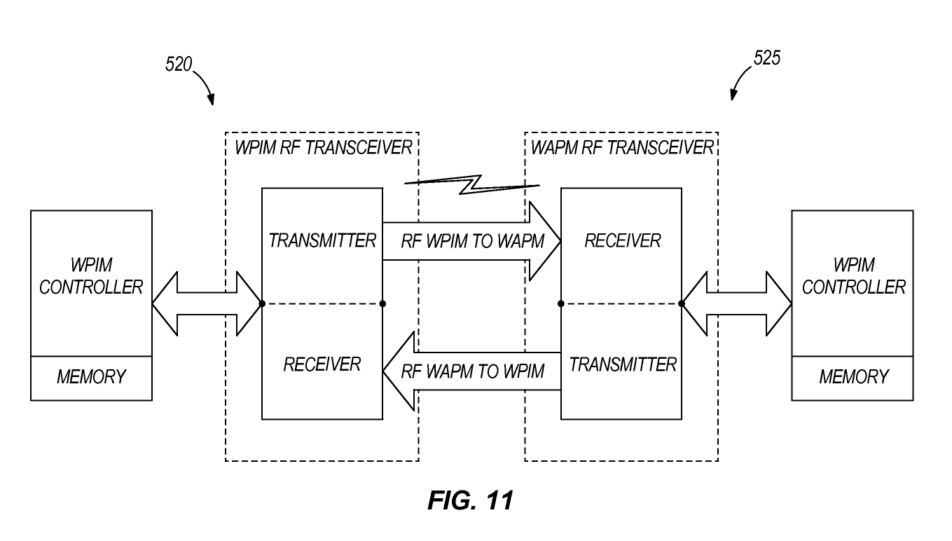

FIG. 12 is a schematic illustration of a floor of a building including a plurality of secured doors and a smart warning system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

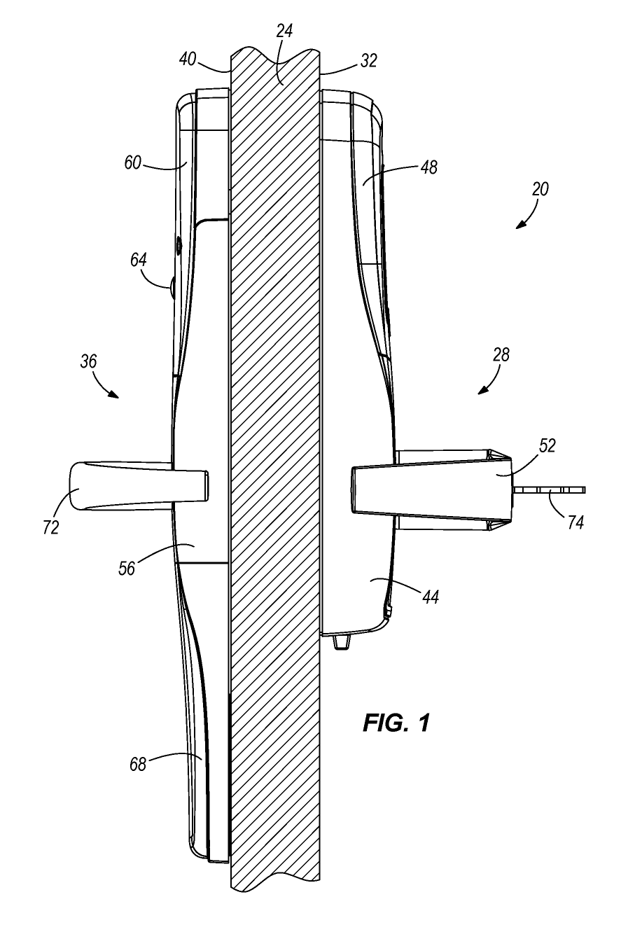

FIG. 1 illustrates an electronic door lock 20 mounted to a door 24 and suitable for use in an access control system 27. The door lock 20 includes an outer portion 28 mounted on an outer side 32 of the door 24 and an inner portion 36 mounted on an inner side 40 of the door 24. The outer portion 28 of the door lock 20 includes an outer escutcheon 44, a credential reader 48, and an outer handle 52. The inner portion 36 of the door lock 20 includes an inner escutcheon 56, a communication module cover 60, an optional pushbutton 64, a battery cover 68, and an inner handle 72.

The terms “inner” and “outer” are used herein to differentiate the two sides of the door and should not be considered as limiting the invention in anyway. In constructions in which one side of the door is in a secured space and the other side of the door is not (e.g., an entry door into a building), the inner side would be in the secured space. However, some constructions may position a door within a space in which both sides of the door are located within a secure space. In these constructions, one side of the door would be considered the inner side while the opposite side would be the outer side. Thus, constructions are possible in which components or features described as being positioned on an inner side of the door could be positioned on an outer side of the door and visa versa. Thus, the terms “inner” and “outer” are sometimes replaced herein with “first” and “second”.

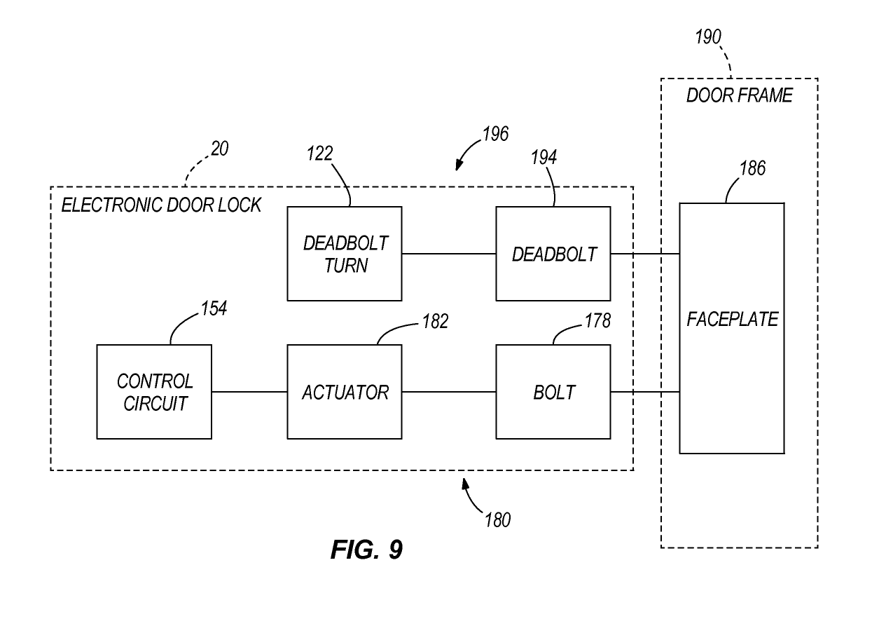

The door lock 20 includes an electromechanical system that allows for the movement of a locking mechanism 180 including an actuator 182, a clutch 179, and a latch 178, which are schematically illustrated in FIG. 9. The latch 178 is movable by the inner handle 72 and the outer handle 52 between a locked position and an unlocked position. When the latch 178 is moved to the locked position, the latch 178 is extended away from the door lock 20 into an opening in a face plate 186 mounted to a door frame 190. The latch 178 inhibits movement of the door 24 when in the extended position. When the latch 178 is moved to the unlocked position, the latch 178 is retracted into the door lock 20 and out of engagement with the face plate 186 to allow a user to open the door 24.

The actuator 182 moves the clutch 179 between an engaged position and a disengaged position to selectively enable and disable the outer handle 52. When the clutch 179 is in the disengaged position, the clutch 179 disengages from the outer handle 52 and the latch 178 such that movement of the outer handle 52 does not cause movement of the latch 178. Thus, when the clutch 179 is in the disengaged position, a user positioned adjacent the outer side 32 cannot gain access to the inner side 40. When the clutch 179 is in the engaged position, the clutch 179 is engages with the outer handle 52 and the latch 178 such that movement of the outer handle 52 causes the latch 178 to move. Thus, when the clutch 179 is in the engaged position, a user positioned adjacent the outer side 32 can move the latch 178, open the door 24, and gain access to the inner side 40. The actuator 182 can include an electric motor, a solenoid, a piezoelectric actuator, a linear actuator, a mechanically actuated device, a different suitable actuator, or a combination thereof to move the clutch 179 to the desired position when a user uses an appropriate key 74 or presents an appropriate credential to the credential reader 48 to allow the user to operate the outer handle 52 and move the latch 178. In some constructions, the actuator 182 is configured to selectively enable and disable the inner handle 72 or both the inner and outer handle.

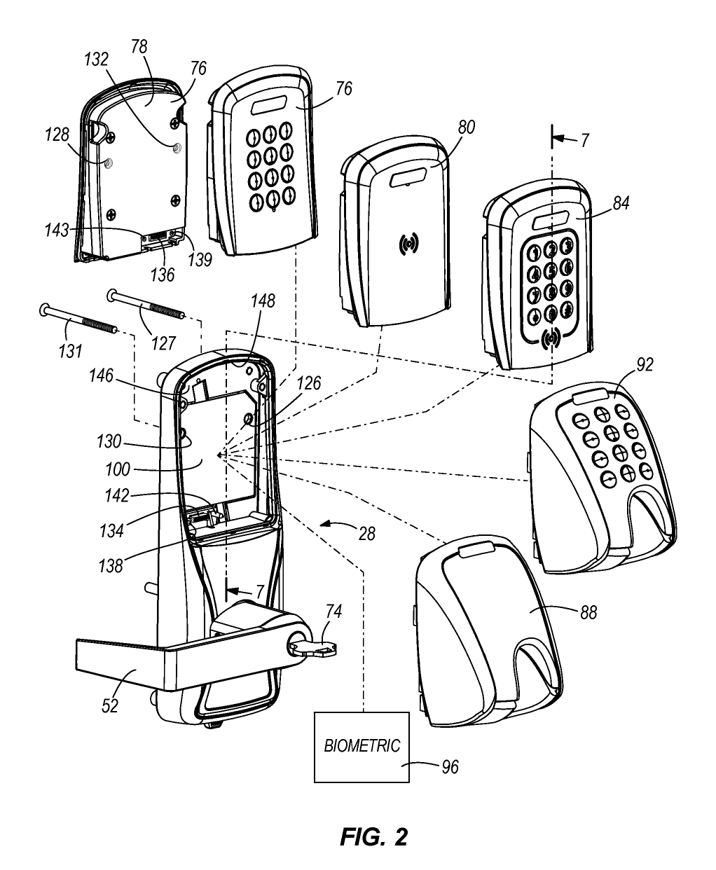

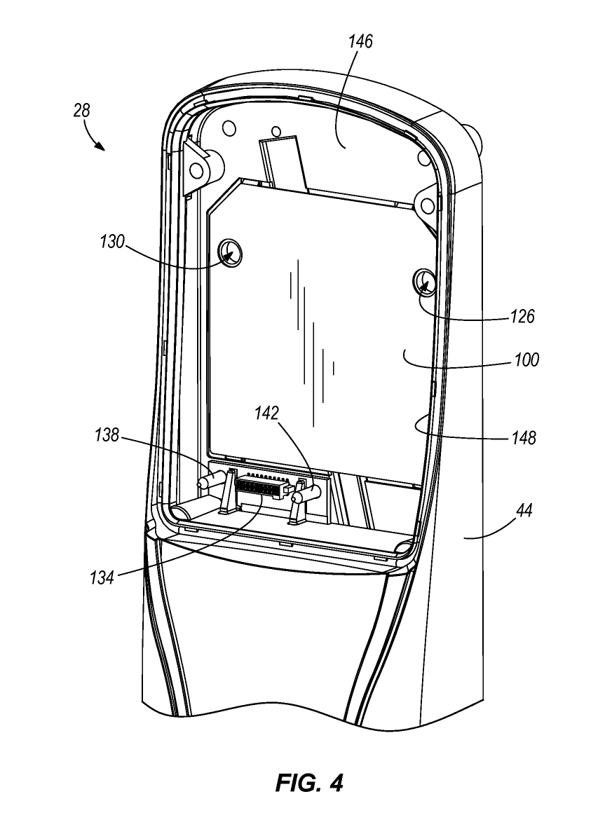

FIG. 2 illustrates the outer portion 28 of the door lock 20. A plurality of input devices (also referred to as credential readers 48) are illustrated including but not limited to a keypad 76, a proximity detector 80, a proximity detector with built-in keypad 84, a magnetic stripe reader 88, a magnetic stripe reader with a built-in keypad 92, and a biometric reader 96. For clarity, the credential reader 48 could include any one of a keypad 76, a proximity detector 80, a proximity detector with built-in keypad 84, a magnetic stripe reader 88, a magnetic stripe reader with a built-in keypad 92, and a biometric reader 96 as well as other types of credential readers such as a smartcard reader, a smartcard reader with built-in keypad, a multitech reader, and a multitech reader with built-in keypad. In fact, the modularity of the arrangement described herein would allow for the use of virtually any type of credential reader desired. The credential readers may include other features such as audio beepers and visual interfaces that include light emitting diodes (LEDs). The credential readers 48 are configured to mount to a mounting portion of an attachment interface 100, which will be described in greater detail with respect to FIG. 4. Each credential reader 48 is self-contained and includes all the necessary electrical components and firmware required for the credential reader 48 to receive an input credential from a user and output the credential or a signal corresponding to the credential to a control circuit 154 (FIG. 9) of the door lock 20. For example, the keypad credential reader 76 is configured to receive a user input (e.g., a numeric or alphanumeric code) and output the entered credential to the control circuit 154 of the door lock 20. The biometric credential reader 96 is configured to receive a user input (e.g., a fingerprint, a scan of the user's hand, a vocal input, a scan of the user's face, a scan of the user's eye, or other biometric data), process the user input, and output data to the control circuit 154 that is representative of the user input. In some embodiments, the biometric credential reader 96 may receive user input in the form of a fingerprint and output the fingerprint data to the control circuit of the door lock 20. In other embodiments, the biometric credential reader 96 may process the input fingerprint and output a statistical representation of the fingerprint data or some other value representative of the fingerprint or the user that provided the fingerprint.

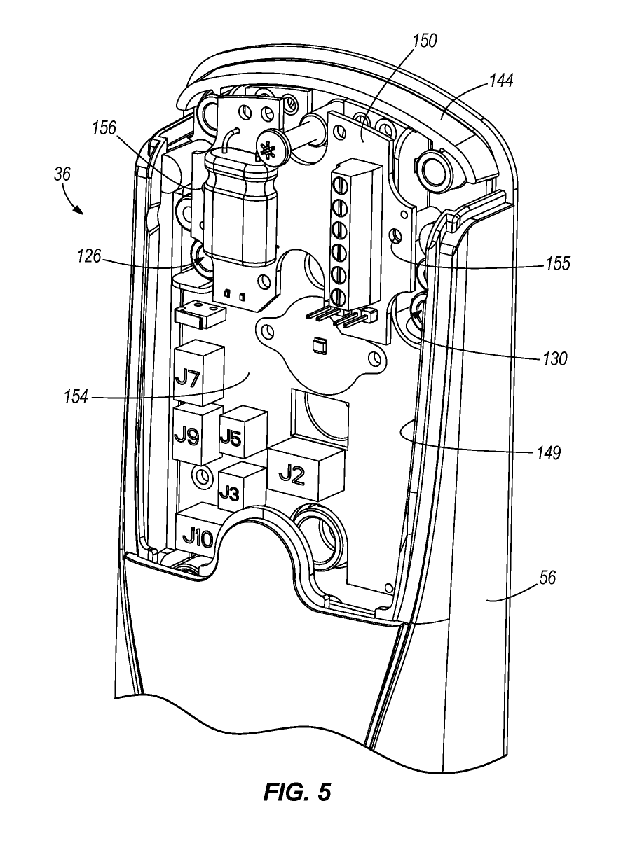

The control circuit 154 of the door lock 20, shown in FIG. 5, includes software or firmware that is operable to receive a variety of credentials or other signals from a variety of different types of credential readers 48. Thus, the user has the option to purchase a door lock and separately purchase any of a variety of credential readers 48, some of which are illustrated in FIG. 2. The software of the control circuit 154 is configured to recognize the type of credential reader 48 attached to the door lock 20 and thus knows what input to expect from the credential reader 48. For example, if a keypad 76 is attached, the software expects a user code. If a magnetic stripe reader with a built-in keypad 92 is attached, the software may be configured to expect both a user code and a magnetic stripe input. The software is configured to receive a signal, from each of a plurality of different types of credential readers 48 that corresponds to the credential input by the user. Thus, no modification to the software is required when a user replaces one type of credential reader (e.g., keypad 76, proximity detection 80, magnetic stripe reader 88, biometric 96, etc.) with a different type of credential reader. Of course, modifications to the software may be performed as desired by the user.

As the user's security needs or preferences change, the user may purchase a new set of credential readers 48 to change the access control system from using one type of credential to a different type of credential. Thus, the user may selectively remove and attach desired credential readers 48 in the field (e.g., at the user's place of business). Of course, the credential readers 48 may also be selectively removed and attached at a factory or place of manufacture. In this way, the electronic door lock 20 contains a high degree of modularity, interchangeability, and upgradeability. Only some credential readers 48 are illustrated in FIG. 2 and discussed herein for exemplary purposes, and the invention is not limited to the types of credential readers 48 discussed and illustrated herein.

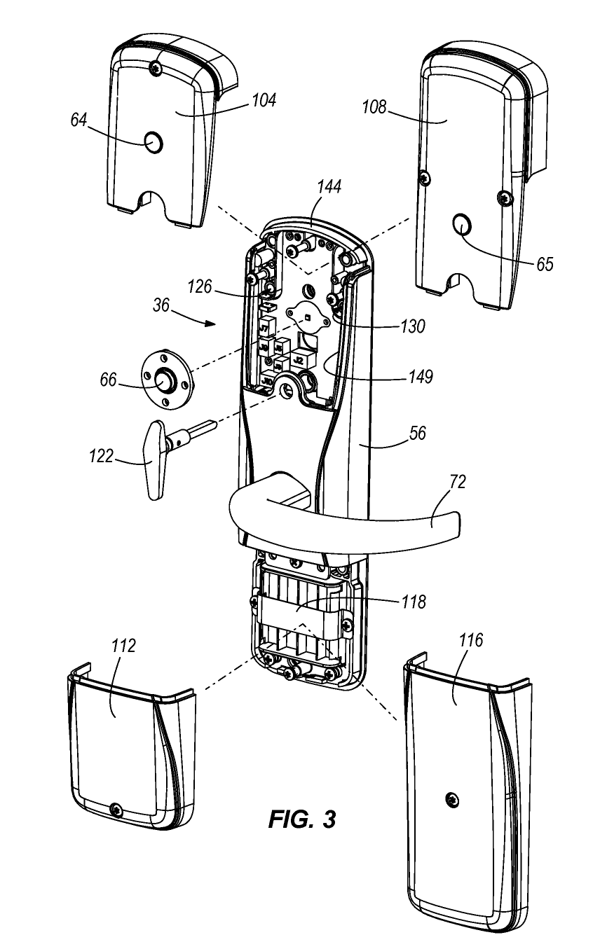

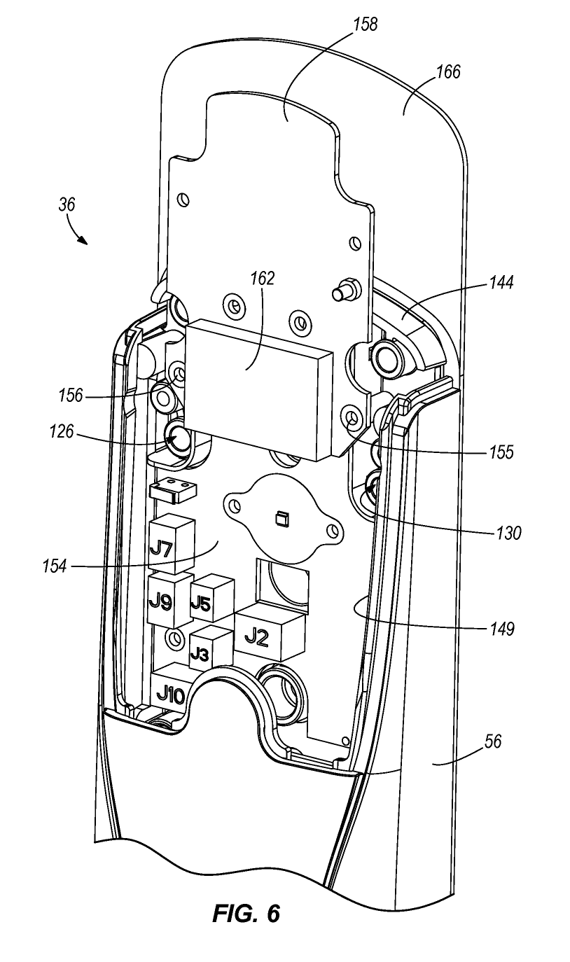

FIG. 3 illustrates the inner portion 36 of the door lock 20 which includes an inner base 144 and the inner escutcheon 56 that defines an inner escutcheon aperture 149. A plurality of communication module covers 104, 108 are illustrated. One cover 104 is configured to cover a wired communication module, and a second cover 108 is configured to cover a wireless communication module, which will be described in detail with respect to FIGS. 5 and 6. The covers 104 and 108 may also be used to substantially close or cover the inner escutcheon aperture 149 when no communication module is present (e.g., offline locks). A first battery cover 112 and a second battery cover 116 are configured to mount to the inner escutcheon 56 to cover the batteries and battery holder 118. A four-battery battery holder 118 is illustrated in FIG. 3, as the construction of FIG. 3 includes 4 batteries. However, if the user desires longer battery life or the credential reader 48 requires more power to operate, the user can use an eight-battery battery holder and mount battery cover 116 to the inner escutcheon 56 to cover the batteries and the battery holder. The eight-battery battery holder is formed by attaching a second four-battery battery holder to the door lock and connecting the second four-battery battery holder to the first four-battery battery holder 118 in order to create an eight-battery battery holder.

The inner portion 36 of the door lock 20 has an optional secondary locking mechanism 196 that includes a deadbolt turn 122 and a deadbolt 194. The deadbolt turn 122 is accessible from inside the access controlled area and is coupled to the deadbolt 194 to allow a user to move the deadbolt 194 (FIG. 9) from a locked position, in which it is extended and engaged in a second opening in the faceplate 186, to an unlocked position, in which the deadbolt 194 is retracted into the door lock 20 and out of engagement with the second opening in the faceplate 186. Thus, a user inside the access controlled area may turn the deadbolt turn 122 to move the deadbolt 194 into engagement with the opening in the faceplate 186, thus inhibiting other users from entering the access controlled area even when an appropriate key 74 is used or when appropriate credentials are presented.

The communication module covers 104, 108 include optional outer pushbuttons 64, 65 mounted to the communication module covers 104, 108, respectively. A corresponding internal button 66 is coupled to the inner base 144. When the cover is mounted on the inner escutcheon 56, the outer pushbutton 64 or 65 aligns with the corresponding internal button 66. When a user positioned inside the access controlled area pushes the pushbutton 64, 65, the corresponding internal button 66 is actuated and sends an electrical signal to the control circuit. The control circuit receives the signal and processes the signal. The internal button 66 may be configured for providing a privacy, lock, unlock, or other function. The control circuit may be programmed to ignore signals received from the pushbutton to effectively disable the pushbutton 66, or the control circuit may be programmed to change the operating mode of the door lock for some period of time or until a second signal is received. For example, the door lock may change from a standard mode of operation to a restricted access mode. When the pushbutton 66 is activated, the door lock 20 may only allow a select number of users to enter the access controlled area, temporarily denying assess to all others who present valid credentials. Of course, other operating modes are also possible and may be predefined and programmed into the electronic door lock software. If the communication module cover 104, 108 does not include an outer pushbutton 64, 65, then the corresponding internal button 66, while still present in the door lock 20, will not be actuatable during normal use.

FIG. 4 illustrates the attachment interface 100 on the outer portion 28 of the door lock 20. The attachment interface 100 is substantially flat and includes mounting apertures 126, 130, a connector 134, and alignment posts 138, 142. The connector 134 extends from the attachment interface 100 in a direction away from the door. The illustrated connector 134 is a standard twenty pin female connector. Of course, in other embodiments, the connector 134 may be positioned in a different location on the attachment interface. In addition, the connector may be a different connector, such as an 8 pin connector, a male connector, or other suitable connectors. In addition, the attachment interface 100 may be a different shape or size if desired.

The credential reader 48, such as one of the credential readers 76, 80, 84, 88, 92, 96 illustrated in FIG. 2 is designed with a corresponding attachment portion 78 and is removably mounted to the attachment interface 100 of the door lock 20. The credential reader 48 includes a second connector 136 that mates with the first connector 134 when the credential reader 48 is mounted on the attachment interface 100. The alignment posts 138, 142 are received in corresponding apertures 139, 143, respectively, in the credential reader 48 to aid in the alignment of the connector 134 of the credential reader 48. Once the credential reader 48 is positioned on the attachment interface 100, mounting fasteners 127, 131 are inserted from the inner side 40 of the door 24. The mounting fasteners 127, 131 pass through apertures 126, 130 and are threadably received in threaded apertures 128, 132 in the credential reader 48 to secure the credential reader 48 to the door lock 20. Because the mounting fasteners 127, 131 secure the credential reader 48 from the inside of the door 24, there is no access to the fasteners 127, 131 from the outer portion 28 of the lock 20 and security is increased. In other embodiments, the attachment interface 100 may include fewer or more alignment posts, differently shaped or positioned alignment posts, or no alignment posts whatsoever. Of course, the attachment interface 100 may include more or less apertures and more or less mounting fasteners if desired. It should be noted that other alignment features could also be employed as alignment posts. In addition, the alignment posts could be formed on the credential readers 48, with corresponding apertures formed in the door lock 20 to facilitate alignment and attachment.

FIG. 5 illustrates a wired communication module 150 that may be used with the door lock 20 of FIG. 1. The inner base 144 is mounted to the inner side 40 of the door. The control circuit 154 is positioned in the inner base 144 and may include electrical components 154 such as an integrated circuit, central processing unit, memory, etc. The wired communication module 150 is removably mounted on the inner base 144 and is electrically connected to the control circuit 154. The wired communication module 150 communicates using wired communications such as serial communication, RS-485, RS-232, Ethernet, etc. The wired communication module 150 is secured to the inner base 144 by inserting fasteners through apertures 155 and 156. The cover 104 illustrated in FIG. 2 is configured to mount to the inner escutcheon 56 to substantially cover the wired communication module and an antenna. Of course, in other constructions, the wired communication module 150 may be used with non-lock devices including but not limited to panel interface modules, wireless reader interfaces, wireless status monitors, wireless portable readers and the like.

If a user wishes to change to, for example, a wireless communication module 158, the user may remove the cover 104 to gain access to the communication module 150. Easy access is granted to the wired communication module 150 through the inner escutcheon aperture 149, and the wired communication module 150 may be removed by removing fasteners in apertures 155 and 156. The wireless communication module 158 may be mounted in the same position to provide wireless capability to the door lock 20, as illustrated in FIG. 6. Thus, the wired communication module 150 may be removed and replaced from the lock without removing the inner escutcheon 56 and without damaging or disturbing the control circuit 154 and the locking mechanism 180.

With reference to FIG. 6, the wireless communication module 158 is removably mounted on the inner base 144 and is electrically connected to the control circuit 154 when mounted thereon. The wireless communication module 158 includes a radio frequency (“RF”) shield 162 and additional circuitry, such as a wireless transmitter or transceiver and the antenna to wirelessly communicate with other devices. Thus, the wireless communication module 158 is larger than the wired communication module 150. As illustrated in FIG. 6, the wireless communication module 158 extends above the inner portion 36 of the door lock 20. A metallic extension 166 is positioned adjacent the door 24 and extends above the door lock 20 a distance that is similar to the wireless communication module 158. The metallic extension 166 contains an adhesive layer for mounting to the door 24. The metallic extension 166 ensures a consistent RF radiation pattern when the door 24 is formed of wood or metal. The RF shield 162 is provided between the wireless communication module 158 and the cover 108 when the cover 108 is mounted on the inner escutcheon 56 to substantially cover the communication module 158. The wireless communication module cover 108 is larger than the wired communication module cover 104 to accommodate the larger wireless communication module 158. In this manner, the inner portion 36 of the door lock is able to accommodate substantially any size of communication module provided that the module is configured to mount to the inner base 144 in a similar position and a cover is designed to mate with the inner escutcheon 56 to substantially cover the communication module. Thus, the door lock 20 is configured to accept a variety of communication modules that are interchangeable, providing the door lock 20 with a greater modularity, flexibility, and interchangeability.

The wireless communication module 158 can be configured to communicate using 900 MHz, WIFI, ZIGBEE, Z-wave, 2.4 GHz, 868 MHz, other radio frequencies, and other standards as desired. The wireless communication module 158 may also be used in non-lock devices such as panel interface modules, wireless portable readers, wireless reader interfaces, wireless status monitors or other wireless devices used in the access control system 27. In offline locks, a communication module is not present. However, the offline lock still includes sufficient space for the addition of a communication module should one be desired. The user can convert to an online wired or wireless lock simply by attaching the wired communication module 150 or the wireless communication module 158 as described above.

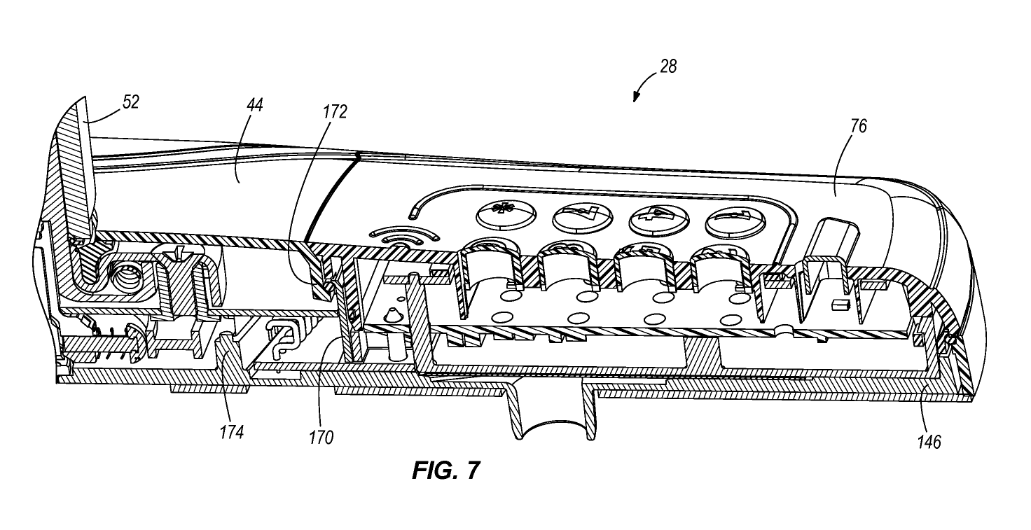

With reference to FIG. 7, the outer portion 28 of the door lock 20 includes a first anti-tamper wall 170 and a second anti-tamper wall 174 that inhibit access to the locking mechanism 180 from the outer portion 28 of the door lock. Specifically, the anti-tamper walls 170 and 174 are positioned to inhibit access to the locking mechanism 180 from an outer escutcheon aperture 148 in the outer escutcheon 44. The first anti-tamper wall 170 extends in a horizontal direction from the outer base 146 to a flange 172 of the outer escutcheon 44 to provide a horizontal barrier between the locking mechanism 180 and the aperture 148. Thus, if an intruder breaks the credential reader 76 and gains access to the upper portion of the door lock 20, the intruder's access to the locking mechanism 180 is blocked by the first anti-tamper wall 170. To increase security, a second anti-tamper wall 174 is positioned below the first anti-tamper wall 170 to provide a second barrier between the upper portion of the door lock 20 and the locking mechanism 180. The second anti-tamper wall 174 extends horizontally from the outer base 146 to at least partially block access to the locking mechanism 180.

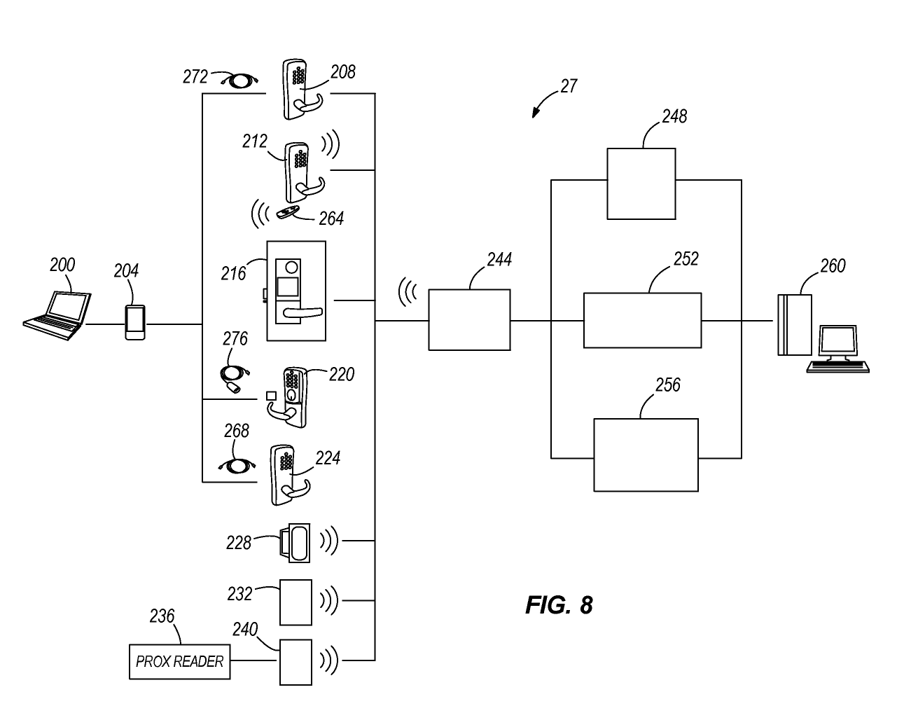

FIG. 8 schematically illustrates an access control system 27 that may include the electronic door lock 20 of FIGS. 1-7. The system includes an optional laptop computer 200, a personal device assistant (PDA) 204, a plurality of door locks and communication modules 208, 212, 216, 220, 224, 228, 232, 236, 240, a panel interface device 244 (e.g., panel interface board (PIB) or panel interface module (PIM)), an access control panel (ACP) 248, 252, or 256, and a server 260.

The laptop 200 and PDA 204 may be used to configure parameters in the access control system 27. The door locks 208, 212, 216, 220, 224 may include one type of door lock or a plurality of types of door locks (e.g., online or offline locks, mortise locks, cylindrical locks, exit locks, etc). The door locks may include wireless credential readers, wired credential readers or a combination thereof. In addition, the access points (e.g., doors, gates, elevators, etc.) may include proximity readers 236, a wireless reader interface (WRI) 240, a wireless status monitor (WSM) 232, a wireless portable reader (WPR) 228, a universal serial bus (USB) enabled electronic lock 224, an electronic lock including a standard electrical connection 220, a BLUETOOTH enabled lock 212 with corresponding dongle 264, or other devices not listed herein. The laptop 200, PDA 204, or a combination thereof may be used during installation and upgrades of the access control system 27. For example, if the door locks require a software upgrade, the upgrade may be performed through the laptop 200 or PDA 204. The laptop 200 and PDA 204 may communicate wirelessly with the door locks or through a wired connection such as a USB cable 268, 272 or other electrical connection 276.

The door locks and communication modules 208, 212, 216, 220, 224, 228, 232, 236, 240 are configured to communicate with the panel interface device 244. The communication may be wireless, with the use of a wireless communication module 158, or the communication may be wired, with the use of a wired communication module 150. The panel interface device 244 is configured to communicate with the ACP 248 via a wired connection. In other constructions, the panel interface device 244 may communicate with third party original equipment manufacture (OEM) equipment 256 or a different control panel, such as BRIGHT BLUE 248. The ACP 252 is configured to communicate with a server 260 such as SMS Express, Select Premium Enterprise system (S/P/E), other software packages, and other third party OEM software and servers. The access control decision may be made by any of the control circuit 154, the panel interface device 244, the ACP 252, 248, or 256, and the server 260. It is also contemplated that the access control decision may be made in the credential reader or the lock itself.

When a user desires access to the access controlled area, the user approaches the credential reader 48, which is positioned on the outer portion 28 of the door lock 20. The user uses the credential reader 48 to enter credentials. This could include entering a pin, swiping a card, providing a biometric sample and the like. The credential reader 48 provides the received credentials or a signal including data representative of the received credentials to the control circuit 154. The control circuit 154 may include an onboard database that has been previously saved and that includes a list of authorized users and the credentials or data associated with each user. The control circuit 154 determines if the received credentials or representative data are valid and makes an access decision. Alternatively, the control circuit 154 may transmit the data to the access control panel 248, 252, or 256, either directly or through the panel interface device 244. The access control panel 248, 252, or 256 may include a database that the access control panel 248, 252, or 256 uses to make an access decision, or the access control panel 248, 252, or 256 may communicate directly with a server 260 that makes the access decision. One of the server 260, access control panel 248, 252, or 256, and the control circuit 154 generates a control signal in response to the access decision.

The control signal is communicated to the control circuit 154, and the control circuit 154 processes the control signal and uses the control signal to actuate the locking mechanism 180 to enable the outside lever and allow the outer handle 52 to move latch 178 to one of the locked position and the unlocked position to provide or inhibit access to the access controlled area. If the control circuit 154 generates the control signal, then the control circuit 154 uses the control signal to operate the locking mechanism 180 accordingly.

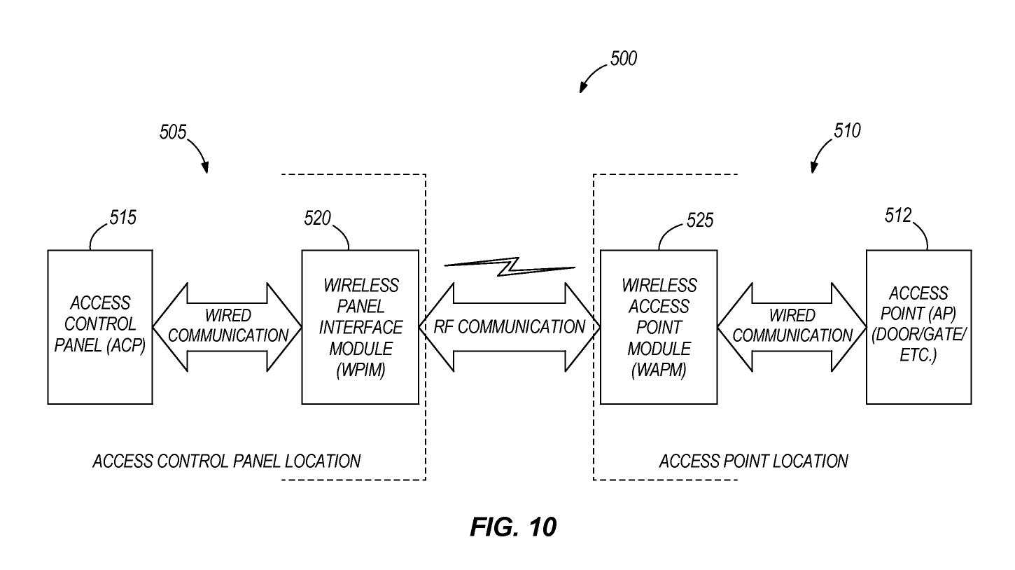

One construction of a lock control system 500 that can be used in the access control system 27 of FIG. 8 is illustrated in FIG. 10. The lock control system 500 includes a remote portion 505 and one or more access point portions 510. The remote portion 505 includes an access control panel 515 and a wireless panel interface module (WPIM) 520 while each of the access point portions 510 includes an access point 512 (e.g., a door, a gate, a locking mechanism, and the like) and a wireless access point module (WAPM) 525. The WPIM 520 and WAPM 525 provide for wireless communication between the access point 512 and the access control panel 515. As such, each of the WPIM 520 and the WAPM 525 may include a transceiver, a controller, and memory. In preferred constructions, similar or identical hardware is utilized for each of the WAPM 525 and the WPIM 520.

The access control panel 515 may include a processor, memory, data storage, and additional components necessary to perform the desired functions. The data storage preferably contains a database of users that may be allowed access to one or more of the access points 512 with which the access control panel 515 can communicate. The database includes, at a minimum, the users credential or some data identifier that identifies the user and the permissions available for that user. The processor is operable to compare an input credential or other input data to the database to make an access decision. In most constructions, the access control panel 515 also provides the ability to modify the database (e.g., add users, remove users, change permissions, change credentials, etc.). In addition, the data storage is sized to store audit records from one or more access points 512 for future analysis. Generally, the access control panel 515 is positioned remotely from the access points 512 such that power requirements and data storage limitations are not a significant issue.

The access point 512 also may include a processor, memory, data storage, and additional components necessary to perform the desired functions. The data storage preferably contains a database of users that may be allowed access to the particular access point 512. In one construction, the data storage is sized to contain a database of up to 5000 users and also to store up to 5000 audit records (e.g., entry attempt, entry denial, errors, time of entry, identity of user, etc.), while still providing a suitable access rate (e.g., less than 1 second to search the user database after presentation of a user credential or user ID). In one construction, the data storage includes serial interface EEPROMs.

To achieve the desired rate of data access, the database can be sorted by an ID or other alphanumeric field. For example, the database could be sorted alphabetically by user. While this provides an easily searchable database, it can be more difficult to insert a new user into the database. In another construction, a red-black tree database structure is employed. This structure provides similar performance to the sorted database when searching for data but offers a significant improvement in performance when inserting a new or updated user into the database. In addition, the red-black tree structure reduces the power requirements of the processor but does require greater data storage when compared to arrangements that use the sorted or unsorted database. In constructions that employ the first database structure, a 512 kb EEPROM and a 1 Mb EEPROM may be employed. In constructions, that employ the red-black data structure, two 1 Mb EEPROMs may be required. Of course larger or smaller EEPROMs or other data storage devices may be used if desired.

It should be noted that other constructions may use a single EEPROM for data storage. In still other constructions, a parallel interface with a memory chip may be employed. In still other constructions, SRAM with a coin cell battery or FLASH memory is employed.

Because both the access point 512 and the access control panel 515 include a database that includes users that are permitted to access the access point 512, both are capable of making an access decision. In a preferred construction, the lock control system 500 can operate in an online mode, an offline mode, or a hybrid mode. In the online mode, the user presents a credential or other data to the access point 512. The access point 512 transfers the data to the access control panel 515 via the WAPM 525 and the WPIM 520. The access control panel 515 then compares the data to the database stored in the access control panel 515 to make the access decision. The decision is then passed to the access point 512 via the WPIM 520 and the WAPM 525. In addition to making the access decision, the access control panel 515 stores the decision results in an audit record such that no storage is required at the access point 512. Because the access control panel 515 and the access point 512 are in communication during online operation, the database at the access point 512 can be updated periodically.

During offline operation, communication between the access point 512 and the access control panel 515 is either unavailable or not desired. The user presents a credential or enters data at the access point 512 and the data is passed to the access point processor. The processor compares the data to the database stored at the access point 512 to make an access decision. The results of the decision, and any other desired information is stored at the access point 512 as an audit record. When communication is reestablished or scheduled, the database can be updated by the access control panel 515 and the audit records can be transmitted to the access control panel 515 and then deleted from the access point 512. In some constructions, no direct communication between the access point 512 and the access control panel 515 is utilized. In these constructions, a handheld lock programmer or other device periodically interfaces with the access point 512 to upload the audit records and refresh the database.

In the hybrid mode of operation, the user presents a credential or other data at the access point 512. The credential reader reads the data and the access point processor compares that data to the database stored at the access point 512. The processor makes the access decision and generates an audit record. Thus, the access decision is made without communication between the access point 512 and the access control panel 515. After the access decision is made, the audit record is transmitted to the access control panel 515. In addition, the access control panel 515 can update the database at the access point 512 on an as needed basis, following any changes to the database at the access control panel 515, or on a real time basis as desired. The transmissions of data in the hybrid mode are accomplished via the WAPM 525 and the WPIM 520 and no handheld lock programmer is required.

The modular design of the electronic door lock 20 provides users with flexibility and an easier way to manage repairs and upgrades of the door locks 20. The user may purchase credential readers 48 separately from the door lock 20. Thus, if a user wishes to change an access control system 27 that uses, for example, keypad credential readers 76 to an access control system that uses, for example, biometric credential readers 96, the user can purchase biometric credential readers 96 for each of the door locks 20. The keypad credential readers 76 can be removed and replaced with the biometric credential readers 96. Because the control circuit 154 includes the necessary software to receive, for example, both keypad credential data and biometric data, no software modification is required. After the biometric credential reader 96 is mounted to the door lock 20 and the appropriate databases are updated with the users biometric data, the access control system 27 will function properly.

For example, some users may wish to change from a security system 27 with keypad entry to a biometric security system 27. To achieve the desired change, the following steps may be performed. The user removes the communication module cover 104 from the inside portion 36 of the door lock 20 (FIG. 3). The user removes the fasteners 127, 131 from the apertures 126 and 130 (FIGS. 2 and 3), the keypad 76 is removed from the attachment interface 100 in the outer portion 28 of the door lock 20, and the biometric credential reader 96 is mounted to the attachment interface 100. The fasteners 127, 131 are reinserted in the apertures 126 and 130 to secure the biometric credential reader 96 to the door lock 20. The communication module cover 104 may then be replaced on the inside portion 36 of the door lock 20.

In some situations, a user may want to change from a wired security system 27 to a wireless security system 27. To do this, the wired communication module 150 (FIG. 5) is removed by removing fasteners from apertures 155 and 156. The metallic extension 166 is mounted to the inner side 40 of the door 24. In some embodiments, the metallic extension 166 is provided with an adhesive backing and a removable film. The film is removed to expose the adhesive, and the metallic extension 166 is mounted to the inside of the door 24 above the inner base 144. The wireless communication module 158 (FIG. 6) is mounted to the door lock 20, and the fasteners are inserted in the apertures 155 and 156 to secure the wireless communication module 158 thereto. The communication module cover 108 is positioned over the wireless communication module 158 and is received by the inner escutcheon 56. The fasteners are replaced in the apertures 155 and 156 to secure the cover 108 to the door lock 20. Of course, the above steps may be performed in a different order. Thus, the communication module 150 or 158 is removable and replaceable without any disassembly of, or damage to the locking mechanism 180, the inner base 144, and the inner escutcheon 56. Furthermore, the communication module 150 or 158 is removable and replaceable without disturbing the control circuit 154 or the locking mechanism 180.

In arrangements such as the one illustrated in FIG. 9, the access point portions are typically not connected to an external power supply. Thus, batteries or other energy storage means must be used to provide power to the access point and the WAPM. The transceiver of the WAPM, illustrated in FIG. 10 is one component that consumes a significant amount of power when it is active. To reduce this power consumption and extend battery life, it is desirable to inactivate, the transceiver and other components when they are not needed.

In one construction, the electronics, including the transceiver, at the WAPM 525 reside in a sleep mode unless required. In order to update the database at the access point 512 or take other action, the WPIM 520 first wakes-up the WAPM 525 using a wake on radio feature. The WPIM 520 transmits a beacon on a predetermined single radio frequency. The WAPM 525 periodically wakes up to listen for the beacon. In one construction, the WAPM 525 looks for the beacon every 5 to 15 seconds with 10 seconds or other intervals (e.g., 3 seconds) being suitable as well. When the WAPM 525 detects the beacon, it initiates a normal heartbeat with the WPIM 520 and the WPIM 520 downloads commands to the WAPM 525 that need to be executed. Generally, the commands fall within a category of global commands that include but are not limited to lock, unlock, status request, and data update. The global commands are not user based but rather are commands that are periodically sent to one or all of the locks simultaneously. For example, if an unauthorized intruder is detected, the system may transition to a lockdown state. In this situation, a lock signal is sent to all of the locks. In another situation, such as when a fire is detected, an unlock signal may be sent to all of the doors to allow for quick and easy escape and unfettered access for fire fighters. Thus, communication, when necessary is initiated by the WPIM 520 which typically does not have the power limitations of the WAPM 525. In preferred constructions, the receiver that detects the beacon operates at a lower power level than the transceiver normally operates at, thereby reducing power consumption.

In one construction, a second generation (2G) radio is employed as the beacon. In other constructions, ZIGBEE, WiFi, and the like could be employed if desired. It should also be noted that preferred constructions include one receiver that listens for the beacon and receives information transmitted by the WAPM 525. The single receiver could be part of a transceiver or separate from a transmitter. In addition, the receiver could be operable at two different power levels, a high level to receive data, and a second low power level to detect the beacon. In still other constructions, two separate receivers are provided to perform the two different tasks. In preferred constructions, the same transceiver is used in the WPIM 520 and the WAPM 525.

In preferred constructions, the wake on radio feature is field configurable on a lock by lock basis. Thus, locks that do not need to wake quickly can further conserve power by not waking in response to the radio.

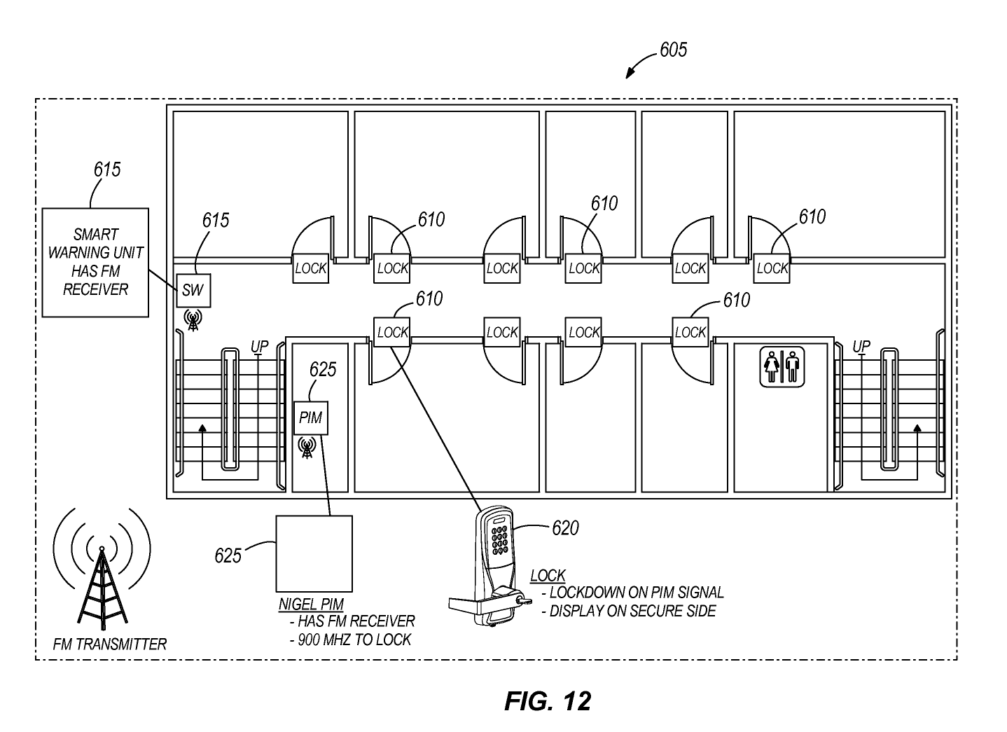

FIG. 12 illustrates an arrangement of a portion of a building 605 such as the floor of a school in which each of the rooms includes an electronic door lock 610. The building 605 also includes a smart warning system that allows for the coordinated actuation of each of the locks 610 or a subset of the locks 610 in a preprogrammed manner. The smart warning system could be programmed to react to different incidents in different ways. For example, if a fire is detected, the smart warning system could be programmed to unlock all of the locks 610 to assure easy egress from the building 605 or floor. However, if an intruder is detected, the smart warning system could immediately lock all of the locks 610 to prevent entry or exit from any of the rooms. Additionally, time delays could be programmed into the system such that the system provides a warning of some sort and then locks the locks 610 after a predetermined time period. The locking delay would allow for the clearing of the halls.

In one construction, a smart warning unit 615 is positioned in each hallway or several are positioned in the hallway and are spaced apart from one another. In constructions where the smart warning system is protecting an area that includes several buildings 605, smart warning units 615 may be positioned outside of buildings 605, on streets, and the like. Each smart warning unit 615 may provide an audible warning device (e.g., bells, whistles, alarms, etc.), a visual warning device (e.g., flashing lights, strobes, multi-colored lights, etc.), and/or a visual display that conveys more detailed information (either textually or using pictographs) regarding the particular situation.

Each smart warning unit 615 includes an FM receiver that allows the security system to communicate with the various smart warning units 615 to assure that they display the correct information. In preferred constructions, the smart warning units 615 include transceivers that allow the smart warning units 615 to transmit information as well. In these constructions, alert conditions can be initiated at each of the smart warning units 615 as well as at other locations. It should be understood that while an FM receiver/transceiver is discussed herein, any form of wireless communication could be employed as desired. In addition, wired communication could also be employed between some or all of the components if desired.

With continued reference to FIG. 12, each lock 610 includes a wireless or wired communication module 620 that provides for communication with the lock panel interface module (PIM) 625. The PIM 625 includes an FM receiver/transceiver that allows for communication with the smart warning units 615 and also includes a transceiver that provides for communication with the various locks 610. In the illustrated construction, the PIM 625 communicates with the locks 610 at 900 Mhz. However, other communication modes are possible and would function with the various locks 610.

Each lock 610 can be provided with a visual or audible display that conveys information during an event. For example, the locks 610 could include a light that changes colors or blinks depending on the situation. In other constructions, a display is provided to convey text messages such as “evacuate”, “stay put”, “go check the smart warning unit for information”, etc. In still other constructions, information is conveyed by each lock 610 using an audible device such as a bell, a whistle, or a computer generated voice that conveys instructions. In addition, combinations of the various visual or audible displays could be employed if desired.

In operation, the smart warning units 615 can be arranged to communicate directly with the locks 610 using the lock's protocol to initiate a desired function. For example, if an intruder is detected, the smart warning units 615 can send signals directly to the locks 610 instructing them to follow a lock down procedure and lock.

In another arrangement, the smart warning units 615 communicate directly with the PIM 625. The PIM 625 then converts the instructions from the smart warning unit protocol into instructions in the lock protocol for each of the locks 610.

In yet another construction, the locks 610 are programmed to receive instructions directly from the smart warning units 615 in the smart warning unit's protocol. In addition to these arrangements, combinations of these arrangements and other arrangements are also possible.

Thus, the invention provides, among other things, an electronic door lock that offers a greater degree of flexibility, interchangeability, and upgradeability.

What is claimed is:

1. A lock system comprising:
an access point including a portion movable between an open position and a closed position;
a lock mechanism coupled to the access point and movable between a locked position in which the access point is maintained in the closed position and an unlocked position in which the access point is freely movable between the open position and the closed position; and
a wireless module coupled to the lock mechanism and operable to move the lock mechanism between the locked position and the unlocked position, the wireless module including a receiver operable in a first mode to periodically listen for a signal and operable in a second mode in response to receipt of the signal to receive data, the first mode consuming a first amount of power that is less than a second amount of power consumed during operation in the second mode.

2. The lock system of claim 1, further comprising a credential reader coupled to the access point and operable to collect a user identifier from a user attempting to move the movable portion to the open position.

3. The lock system of claim 2, wherein the wireless module includes a processor and a memory storage device.

4. The lock system of claim 3, wherein the memory storage device includes a database including valid user identifiers, and wherein the processor is operable to compare the collected user identifier to the stored valid user identifiers to make an access decision at the access point.

5. The lock system of claim 4, wherein the only communication required to make an access decision is a communication between the credential reader and the wireless module.

6. The lock system of claim 2, wherein the credential reader includes at least one of a card reader, a keypad, a biometric reader, and a proximity detector.

7. The lock system of claim 1, wherein the received data is a global command and the lock mechanism is transitioned to and maintained in one of a locked and unlocked state in response to the receipt of the global command.

8. The lock system of claim 7, wherein the access point is one of a plurality of access points, the lock mechanism is one of a plurality of lock mechanisms each associated with one of the access points and the wireless module is one of a plurality of wireless modules, each wireless module associated with one of the lock mechanisms.

9. The lock system of claim 8, wherein each receiver listens for the signal at a period that is selected to assure that each of the lock mechanisms transitions to the locked or unlocked state less than five seconds after the transmission of the global command.

10. The lock system of claim 1, wherein the receiver listens for the signal at an interval between about 5 seconds and 15 seconds.

11. The lock system of claim 1, wherein the receiver includes a first receiver that operates at a first power level to listen for the signal and a second receiver separate from the first receiver and operable at a second power level greater than the first power level to receive the data.

12. The lock system of claim 1, wherein the receiver is a part of a transceiver.

13. A lock system comprising:
an access point having a portion that is movable between an open position and a closed position;
a lock mechanism coupled to the access point and movable between a locked position in which the access point is maintained in the closed position and an unlocked position in which the access point is freely movable between the open position and the closed position;
a first receiver periodically operable at a first power level to detect a beacon; and
a second receiver separate from the first receiver and operable at a second power level greater than the first power level to receive data, the second receiver operable in a sleep mode and an active mode, the second receiver transitioning from the sleep mode to the active mode in response to receipt of the beacon by the first receiver.

14. The lock system of claim 13, further comprising a credential reader coupled to the access point and operable to collect a user identifier from a user attempting to move the movable portion to the open position.

15. The lock system of claim 14, further comprising a processor and a memory storage device, wherein the memory storage device includes a database including valid user identifiers, and wherein the processor is operable to compare the collected user identifier to the stored valid user identifiers to make an access decision at the access point.

16. The lock system of claim 14, wherein the credential reader includes at least one of a card reader, a keypad, a biometric reader, and a proximity detector.

17. The lock system of claim 13, wherein the received data is a global command and the lock mechanism is transitioned to and maintained in one of a locked and unlocked state in response to the receipt of the global command.

18. The lock system of claim 17, wherein the access point is one of a plurality of access points, the lock mechanism is one of a plurality of lock mechanisms each associated with one of the access points, the first receiver is one of a plurality of first receivers, and the second receiver is one of a plurality of second receivers, each first receiver and second receiver associated with one of the lock mechanisms.

19. The lock system of claim 18, wherein each first receiver listens for the signal at a period that is selected to assure that each of the lock mechanisms transitions to the locked or unlocked state less than five seconds after the transmission of the global command.

20. The lock system of claim 13, wherein the receiver listens for the signal at an interval between about 5 seconds and 15 seconds.

21. The lock system of claim 13, wherein the second receiver is a part of a transceiver.

22. A method of operating a wireless lock system, the method comprising:
periodically operating a plurality of receivers at a low power level to detect a beacon, each receiver associated with a different lock mechanism;
transitioning each receiver to a high power level in response to detection of the beacon;
receiving data using each receiver while operating at the high power level; and
transitioning each lock mechanism to one of a locked position and an unlocked position in response to the received data.

23. The method of claim 20, wherein the period at which the receivers attempt to detect the beacon is between about 5 seconds and 15 seconds.
